(19) United States
(12) Patent Application Publication
(10) Pub. No.: US 2019/0206252 A1
(43) Pub. Date: Jul. 4, 2019

(54) CONCEPT FOR SENSING AN ENVIRONMENT OF A MOTOR VEHICLE

(71) Applicant: Robert Bosch GmbH, Stuttgart (DE)

(72) Inventors: Albrecht Irion, Stuttgart (DE); Philipp Mayer, Ho Chi Minh City (VN); Rolf Nicodemus, Bietigheim-Bissingen (DE); Stefan Nordbruch, Kornwestheim (DE)

(21) Appl. No.: 16/330,851

(22) PCT Filed: Jul. 31, 2017
(86) PCT No.: PCT/EP2017/069353

§ 371 Date: Mar. 6, 2019

(30) Foreign Application Priority Data
Sep. 9, 2016 (DE) 10 2016 217 205.0

(51) Int. Cl. G08G 1/14

(52) U.S. Cl. CPC G08G 1/143; G08G 1/144; G08G 1/147

(57) ABSTRACT

A device for sensing a motor vehicle environment (MVE), including: a parking control unit (PCU); a first data processing device (DP); at least one sensor unit (SU), each having at least one environment sensor(s) (ES) for sensing a MVE, and a communications interface (CI) for wired transmission of ES data; the PCU having a CI to receive the ES data; the first DP having a communications module (CM) to receive the ES data from at least one CI of the SU(s); the CM transmitting the ES data and environment data based on the ES data by a wireless communications network (WCN) to a second DP, so that it can transmit the ES data and/or environment data via another WCN to a Cloud server. Also described is a motor vehicle, a method for MVE sensing, a method for adapting a motor vehicle, a system for MVE sensing, and a computer program.

### FIELD OF THE INVENTION

The present invention relates to a device and a method for sensing an environment of a motor vehicle. In addition, the present invention relates to a motor vehicle. The present invention relates to a method for adapting a motor vehicle. The present invention relates to a system for sensing an environment of a motor vehicle. Furthermore, the present invention relates to a computer program.

### BACKGROUND INFORMATION

Systems for ascertaining parking spaces along a roadside are known as such. They generally include two subsystems, i.e. a first subsystem is located inside the vehicle, and a second subsystem is located in a Cloud infrastructure.

The subsystem that is located in the motor vehicle includes environment sensors which scan a roadside when the motor vehicle is traveling along the roadside. The raw sensor data are subsequently further processed in a parking control unit of the motor vehicle. For instance, this means that occupied or free areas are ascertained in the parking control unit and also their dimensions or distances from one another.

In what is referred to as a head unit, i.e. the main control unit of the motor vehicle, or possibly in a further computer, a position of the occupied or free areas is ascertained in addition, e.g., with the aid of a GPS sensor.

Via a communications unit of the motor vehicle, these data (position of the ascertained area and its occupancy state, i.e. free or occupied) are transmitted to the subsystem, which is located in the Cloud infrastructure.

The subsystem located in the Cloud infrastructure processes these data and determines whether or not a free area is a driveway, for instance. These further processed data are then transmitted back to the motor vehicle or to further motor vehicles, for example, so that the information contained in these further processed data is able to be displayed in the respective motor vehicle and/or may be made available via the Internet.

In other words, a correspondingly developed parking control unit must be located in the motor vehicle. More specifically, a position-ascertainment component such as a GPS sensor must be located within the motor vehicle. In particular, a communications component has to be provided in the motor vehicle for the communication with the subsystem which is located within the Cloud infrastructure.

In addition, adaptations to a vehicle-internal communication are usually required, for instance to a bus system of the motor vehicle.

It is for these reasons that the first subsystem which is located in the motor vehicle is unable to be installed in an already finished motor vehicle, i.e. after its production, or can be installed only with considerable adaptations.

### DISCLOSURE OF THE INVENTION

An objective on which the present invention is based is to provide an efficient concept for the efficient sensing of an environment of the motor vehicle that overcomes the afore-described disadvantages and efficiently allows a motor vehicle to become part of a system for ascertaining parking space areas also retroactively, i.e. after its production.

This objective may be achieved by the respective subject matter of the descriptions herein. Advantageous further developments of the present invention are the subject matter of the respective further descriptions herein.

According to one aspect, a device for sensing an environment of a motor vehicle is provided, which includes:
a parking control unit;
a first data processing device;
one or a plurality of sensor unit(s), each including one or a plurality of environment sensors for sensing an environment of a motor vehicle, and a communications interface for the transmission of environment sensor data corresponding to the respective sensing, in a wired manner, the parking control unit has a communications interface which is configured to receive the environment sensor data in a wired manner,
the first data processing device having a communications module which is configured to receive the environment sensor data from at least one communications interface of the sensor unit(s) in a wired manner,
the communications module being configured to transmit the environment sensor data and/or environment data based on the environment sensor data by way of a wireless communications network to a second data processing device, so that the second data processing device is able to transmit the environment sensor data and/or the environment data by way of a further wireless communications network to a Cloud server.

According to a further aspect, a motor vehicle is provided, which includes the device for sensing an environment of a motor vehicle.

According to an additional aspect, a method for sensing an environment of a motor vehicle with the aid of the device for sensing an environment of a motor vehicle is provided, the method including the following steps:
sensing an environment of a motor vehicle with the aid of the environment sensor(s);
transmitting environment sensor data that corresponds to the sensing in a wired manner using the respective communications interface of the sensor unit(s);
receiving the environment sensor data in a wired manner with the aid of the first data processing device; and
transmitting the environment sensor data and/or environment data based on the environment sensor data via a wireless communications network with the aid of the first data processing device to a second data processing device, so that the second data processing device is able to transmit the environment sensor data and/or the environment data via a further wireless communications network to a Cloud server.

According to a further aspect, a method for adapting a motor vehicle is provided, the motor vehicle having a parking control unit and one or a plurality of sensor unit(s), each having one or a plurality of environment sensor(s) for sensing an environment of a motor vehicle, and a communications interface for the wired transmission of environment sensor data corresponding to the respective sensing via a bus, especially a CAN bus, of the motor vehicle, the parking control unit having a bus communications interface for the wired receiving of the environment sensor data via the bus, a first data processing device which includes a communications module being installed in the motor vehicle, the communications module being configured to receive the environment sensor data in a wired manner, e.g., via the bus, the communications module being configured to transmit the environment sensor data and/or the environment data based on the environment sensor data via a wireless communications network to a second data processing device.

According to one aspect, a system for sensing an environment of a motor vehicle is provided, the system including:
the device for sensing an environment of a motor vehicle, and
a Cloud server, which includes a communications interface, which is configured to receive the environment sensor data and/or the environment data via the further wireless communications network.

According to a further aspect, a computer program is provided, which includes program code for carrying out the method for sensing an environment of a motor vehicle when the computer program is executed on a computer.

The present invention is based on the understanding that the aforementioned objective is able to be achieved by providing a first data processing device, which, apart from the parking control unit, receives the environment sensor data in a wired manner from the environment sensors and the sensor units respectively, and which transmits these environment sensor data and/or environment data based on these environment sensor data by way of a wireless communications network to a second data processing device. This then advantageously enables the second data processing device to transmit these data via a further wireless communications network to a Cloud server. In other words, the environment sensor data and the environment data, respectively, are transmitted from the first data processing device to the second data processing device in a wireless manner and not via a bus. In an advantageous manner, it is therefore not necessary to perform adaptations to a motor vehicle bus for a communications connection between the first data processing device and the second data processing device.

Thus, a motor vehicle is able to take part in a system for ascertaining parking areas even after its production by simply having a first data processing device installed. Once the motor vehicle has been adapted, the motor vehicle thus has the first data processing device in addition to the parking control unit, the first data processing device communicates with the second data processing device, which then in turn communicates with the Cloud server. In this way, such an adapted motor vehicle is able to efficiently participate in a system for ascertaining parking spaces despite not having been able to do so prior to its adaptation. This is because suitable communications possibilities with the Cloud server, for instance, were lacking prior to the adaptation. As a rule, the parking control unit is unable or not equipped to communicate with the Cloud server on its own. By providing the first data processing device, a first step is therefore taken for the establishment of a communications connection to the Cloud server.

The second data processing device then assumes the communication between the first data processing device and the Cloud server. The provision of such a second data processing device is able to be undertaken in an efficient manner. As described in the following text, it is sufficient to provide a mobile user terminal or a main control unit, for example. Drivers of motor vehicles usually already carry a mobile user terminal, e.g., a mobile phone. This will then take over the communication between the first data processing device and the Cloud server.

As a rule, motor vehicles are already equipped with a main control unit so that a suitable device for communicating with the Cloud server is already available.

In particular, no changes have to be made to the sensor units due to the concept according to the present invention. It is therefore possible to continue the use of the sensor units that were already installed in the vehicle during the production of the vehicle.

An already existing parking control unit must usually also no longer be modified further.

In addition, because of the concept according to the present invention, no changes, or at least no significant changes, are required on and/or in a bus of the motor vehicle in view of the fact that the environment sensor data are directly transmitted or sent from the at least one communications interface of the sensor unit(s) to the first data processing device.

According to one specific embodiment, it is provided that the device includes the second data processing device, and the second data processing device is configured to transmit the environment sensor signals and/or the environment data to the Cloud server via the further wireless communications system.

According to one further specific embodiment, it is provided that the second data processing device is a mobile user terminal, in particular a mobile phone.

For instance, this provides the technical advantage of allowing for the efficient utilization of a mobile user terminal, especially a mobile phone, of a driver of the motor vehicle, for example.

According to one specific embodiment, it is provided that the second data processing device is a main control unit for the motor vehicle.

For example, this provides the technical advantage of an efficient use of the main control unit.

A main control unit in the sense of the description, for instance, may be described as a head unit.

According to one specific embodiment, it is provided that the parking control unit and the first data processing device are switched in parallel with at least one of the respective communications interfaces of the sensor unit(s) in terms of communications technology, so that the parking control unit and the first data processing device are directly connected to the at least one communications interface in each case.

For example, this provides the technical advantage that the respective communication between the sensor unit(s) and the parking control unit and/or the first data processing device is able to be carried out independently of one another. The parking control unit and the first data processing device communicate directly and on their own with the corresponding sensor unit or the corresponding sensor units.

It is provided, for instance, that the parking control unit and the first data processing device are connected, or are able to be connected, to the corresponding sensor unit(s) via a separate communications line, such as via a separate communications cable, in each case.

The respective communications line between the parking control unit and the sensor unit(s) is part of a bus such as part of a

CAN or a FlexRay bus, for instance.

For example, the respective communications line between the first data processing device and the sensor unit(s) is not part of a bus, and especially not a part of the bus of which the respective communications line between the parking control unit and the sensor unit(s) is a part.

The wording that the parking control unit and the first data processing device are switched in parallel with at least one of the respective communications interfaces of the sensor unit(s) in terms of communication technology particularly includes the case that the parking control unit and the first data processing device are switched in parallel with precisely one of the communications interfaces of the sensor unit(s) from the standpoint of communication technology.

The wording that the parking control unit and the first data processing device are switched in parallel with at least one of the respective communications interfaces of the sensor unit(s) from the standpoint of communication technology particularly includes the case that the parking control unit and the first data processing device are switched in parallel with a plurality, in particular with all, of the respective communications interfaces of the sensor unit(s) from the standpoint of communication technology.

According to one specific embodiment, the first data processing device is connected to precisely one sensor unit in terms of communications technology, in particular to a plurality of sensor units, such as to all sensor units from the standpoint of communications technology.

According to one still further specific embodiment, it is provided that the parking control unit is connected indirectly to at least one of the respective communications interfaces from the standpoint of communications technology with the aid of the first data processing device, so that the environment sensor data transmitted using the at least one communications interface are able to be looped through the first data processing device to the parking control unit.

For example, this provides the technical advantage that no more than one communications line, in particular one communications cable, from the parking control unit to the first data processing device is now required rather than a plurality of communications lines between the parking control unit and the sensor units.

In other words, the environment sensor data are first transmitted from the respective communications interface to the first data processing device, looped through it and then transmitted further to the parking control unit.

For instance, it is provided that the first data processing device is connected to the at least one communications interface of the sensor unit(s) with the aid of a separate communications line.

The wording that the parking control unit is indirectly connected in terms of communications technology to at least one of the respective communications interfaces using the first data processing device particularly includes the case that the parking control unit is indirectly connected to a communications interface of precisely one sensor unit with the aid of the first data processing device.

The wording that the parking control unit is indirectly connected to at least one of the respective communications interfaces in terms of communications technology with the aid of the first data processing device particularly includes the case that the parking control unit is indirectly connected to a communications interface of a plurality of sensor units, and in particular to all sensor units, with the aid of the first data processing device.

In one specific embodiment, it is provided that the parking control unit and the first data processing device are switched in parallel with at least one of the respective communications interfaces of the sensor unit(s) from the standpoint of communications technology, so that the parking control unit and the first data processing device are directly connected to the at least one communications interface in each case, the parking control unit being indirectly connected with the aid of the first data processing device to at least one of the respective communications interfaces in terms of communications technology, so that the environment sensor data transmitted using the at least one communications interface are able to be looped through the first data processing device to the parking control unit.

In other words, this particularly means that both the indirect communications connection and the parallel connection are able to be provided in a shared embodiment.

According to one specific embodiment, it is provided that the communications module has a first communications interface, in particular a bus communications interface, for the wired receiving of the environment sensor data, and that it has a second communications interface, in particular a WLAN or a Bluetooth communications interface, for the transmission of the environment sensor data and/or the environment data to the second data processing device.

For example, this achieves the technical advantage that the data are able to be transmitted, i.e. in particular transmitted or received, in an efficient manner.

This means, for example, that the wireless communications network is a WLAN communications network or a Bluetooth communications network, for instance.

Thus, this means, for instance, that the environment sensor data are transmitted from the sensor unit(s) via a bus communications system to the communications module of the first data processing unit.

A bus communications system may also be referred to as a bus system in this context. A bus in the sense of this description includes a CAN and/or a FlexRay bus, for example.

Thus, this particularly means that the bus system includes a CAN and/or a FlexRay bus, for instance.

A bus in the sense of the description may particularly be referred to as a motor vehicle bus and/or a communications bus.

According to one still further specific embodiment, it is provided that the further wireless communications network includes a mobile telephony communications network and/or a WLAN communications network.

In one specific embodiment, the second data processing device includes a first communications interface, in particular a WLAN or a Bluetooth communications interface, for the wireless receiving of the environment sensor data or environment data via the wireless communications network, and it includes a second communications interface, in particular a mobile telephony communications interface or a WLAN communications interface, for transmitting the environment sensor data and/or the environment data to the Cloud server via the further communications network.

If the further communications network is a WLAN communications network, then the first communications interface, for example, may be used for transmitting the environment data or the environment sensor data, provided it is configured as a WLAN communications interface.

According to one specific embodiment, it is provided that the parking control unit and/or the first data processing device and/or the second data processing device is/are configured to ascertain on the basis of the environment sensor data dimensions of a free area of the environment and/or dimensions of an area of the environment that is occupied by a motor vehicle and to ascertain environment data that correspond to the ascertainment of the respective dimensions.

This provides the particular technical advantage that the parking control unit and/or the first data processing device and/or the second data processing device is or are used, or may be used, in an efficient manner in each case. More specifically, this provides the technical advantage that the Cloud server is able to be relieved of this task.

In one specific embodiment, it is provided that a position sensor for sensing a position of the motor vehicle is provided, and the first data processing device is configured to transmit position data that correspond to the sensing of the position to the second data processing device, so that the second data processing device is able to transmit the position data via the further wireless communications network to the Cloud server.

This results in the particular technical advantage that the position of the sensed environment is able to be ascertained in an efficient manner and be efficiently made available to the Cloud server remotely from the motor vehicle.

According to one specific embodiment, a position sensor for sensing a position of the motor vehicle is provided, and the second data processing device is configured to transmit position data that correspond to the sensing of the position via the further wireless communications network to the Cloud server.

This achieves the particular technical advantage that the position of the sensed environment is efficiently able to be ascertained and be made available to the Cloud server remotely from the motor vehicle and in an efficient manner.

According to one further specific embodiment, it is provided that the position sensor is integrated into the first data processing device or into the second data processing device.

In one specific embodiment, it is provided that a position sensor is integrated into the first data processing device and in the second data processing device in each case.

In one specific embodiment, it is provided that the sensor unit(s) is/are developed to encrypt the environment sensor data, and the respective communications interface of the sensor unit(s) is configured to transmit the encrypted environment sensor data in a wired manner to the first data processing device.

This results in the particular technical advantage that the environment sensor data are able to be protected from an unauthorized readout.

In one specific embodiment, it is provided that the sensor unit(s) is/are configured to encrypt the environment data in each case, and the respective communications interface of the sensor unit(s) is configured to transmit the encrypted environment sensor data to the parking control unit in a wired manner.

This achieves the particular technical advantage that the environment sensor data are able to be protected from an unauthorized readout.

According to one specific embodiment, it is provided that the communications module is configured to receive the encrypted environment sensor data in a wireless manner.

According to one specific embodiment, it is provided that the first data processing device is configured to decrypt the encrypted environment sensor data.

According to one specific embodiment, it is provided that the first data processing device is configured to encrypt unencrypted environment sensor data and/or unencrypted environment data.

According to one specific embodiment, it is provided that the second data processing device is configured to decrypt the encrypted environment sensor data.

According to one specific embodiment, it is provided that the second data processing device is configured to encrypt unencrypted environment sensor data and/or unencrypted environment data.

According to one specific embodiment, it is provided that the parking control unit is configured to decrypt the encrypted environment sensor data.

According to one specific embodiment, it is provided that the parking control unit is configured to encrypt unencrypted environment sensor data and/or unencrypted environment data.

According to one specific embodiment, it is provided that the communications module is configured to transmit the encrypted environment sensor data and/or the encrypted environment data via the wireless communications network to the second data processing device.

According to one specific embodiment, it is provided that the second data processing device is configured to transmit the encrypted environment sensor data and/or the encrypted environment data via the further wireless communications network to the Cloud server.

According to one specific embodiment, the sensor unit(s) and/or the first data processing device and/or the second data processing device and/or the parking control unit include(s) a processor in each case, which is configured to encrypt or decrypt the environment sensor data.

According to one specific embodiment, the environment sensor data are raw environment sensor data or include raw environment sensor data.

An environment sensor in the sense of the description, for example, is one of the following environment sensors: a radar sensor, lidar sensor, an ultrasonic sensor, a magnetic sensor, laser sensor, video sensor, in particular a video sensor of a video camera, and an infrared sensor.

If multiple environment sensors are provided, they have an identical or a different development.

The wording ‘respectively’ in particular encompasses the wording ‘and/or’.

In one specific embodiment, it is provided that the parking control unit is configured to park and/or unpark a motor vehicle at least semi-autonomously, and in particular fully autonomously.

The wording that the parking control unit is configured to park and/or unpark a motor vehicle at least semi-autonomously, and in particular fully autonomously in particular means that the parking control unit is configured to control a transverse guidance and/or a longitudinal guidance of the motor vehicle.

In one specific embodiment, it is provided that the parking control unit is configured to ascertain a distance of a motor vehicle to an object in the environment of the motor vehicle based on the environment sensor data, such as during a parking and/or unparking maneuver of the motor vehicle. The parking control unit may be configured to output a warning and/or control a warning device for outputting a warning based on the ascertained distance if the ascertained distance is less than or less than or equal to a predefined threshold value. The warning device, for instance, includes an optical and/or a haptic and/or an acoustic signal generator. For example, the warning device includes a display device for displaying the warning.

For instance, this achieves the technical advantage that the driver of the motor vehicle can be efficiently warned so that a collision of the motor vehicle with the object is able to be avoided.

The warning device is encompassed by the device for sensing an environment or by the motor vehicle, for example.

In one specific embodiment, it is provided that the parking control unit is configured to measure a free parking space in response to a user command and based on the environment sensor data, especially prior to a parking maneuver of the motor vehicle.

The user command, for example, may come from the driver or a further passenger of the motor vehicle. In other words, this particularly means that the parking control unit measures a free parking space upon request, and does so based on the environment sensor data.

The parking control unit supplies a result of this measuring operation, e.g., to a display unit which displays the result.

A result particularly encompasses the information whether or not the motor vehicle fits into the parking space.

In one specific embodiment, it is provided that the first data processing unit has an electrical connection for connecting an electrical line in order to be able to supply the first data processing device with electrical energy from a vehicle battery.

For instance, this achieves the technical advantage that the first data processing device is able to be efficiently supplied with electrical energy.

In one specific embodiment, it is provided that the first data processing device is connected in an electrically conductive manner to the battery of the motor vehicle via an electrical line which is connected to the electrical connection.

According to one specific embodiment, it is provided that the present method for sensing an environment of a motor vehicle is carried out or implemented with the aid of the device for sensing an environment of a motor vehicle.

According to one specific embodiment, it is provided that the device for sensing an environment of a motor vehicle is configured or set up to carry out or implement the present method for sensing an environment of a motor vehicle.

According to one specific embodiment, it is provided that the first data processing device has an electrical energy store for the internal electrical energy supply.

This achieves the particular technical advantage that the first data processing device is able to be operated in an autonomous manner.

For example, the electrical energy store includes a battery or a plurality of batteries and/or one or plurality of accumulator(s).

Technical functionalities of the present method for sensing an environment of a motor vehicle similarly result from corresponding technical functionalities of the device for sensing an environment of a motor vehicle, and vice versa.

According to one specific embodiment, it is provided that the motor vehicle is configured or set up to carry out or implement the present method for sensing an environment of a motor vehicle.

According to one specific embodiment, for example, the first data processing device according to the present method for adapting a motor vehicle is the first data processing device according to the device for sensing an environment of a motor vehicle, for instance.

Technical functionalities of the system for sensing an environment of a motor vehicle similarly result from corresponding technical functionalities of the present method or the device for sensing an environment of a motor vehicle, and vice versa.

According to one specific embodiment of the method for adapting a motor vehicle, it is provided that a second data processing device is installed in the motor vehicle. The second data processing device is a mobile user terminal, for instance, in particular a mobile telephone or a main control unit.

Technical functionalities of the method for adapting a motor vehicle similarly result from corresponding technical functionalities of the device for sensing an environment of a motor vehicle, and vice versa.

In one specific embodiment, it is provided that the communications module is connected by wire only to the particular communications interface of the sensor unit(s) whose environment sensors are laterally disposed to the right and/or left on the motor vehicle.

For instance, this results in the technical advantage that only these sensor units need to be connected to the communications module, which, may reduce the wiring expense, for example.

Since occupied or free parking spaces in the environment of the motor vehicle are normally located to the left and/or right of the motor vehicle, it is generally sufficient that only these sensor units have to communicate with the data processing device.

‘Right’ and ‘left’ refer to a main driving direction of the motor vehicle.

In one specific embodiment of the present method for sensing an environment of a motor vehicle, the method includes the following steps:
wirelessly receiving the environment sensor data or the environment data with the aid of the second data processing device;
transmitting the environment sensor data and/or the environment data via the further wireless communications network to the Cloud server with the aid of the second data processing device.

In one specific embodiment, the motor vehicle includes a bus. The bus may be referred to as a motor vehicle bus and/or as a communications bus, for instance.

Environment sensor data denote data that may come directly from the environment sensors and may include raw environment sensor data, for instance.

Environment data denote data that were calculated or ascertained based on the environment data. Environment data, for example, include dimensions of an occupied or free area and/or an occupancy state of an area.

The parking control unit or the first data processing device and/or the second data processing device may ascertain corresponding environment data based on the environment sensor data, for instance. The first data processing device transmits the corresponding data by way of the wireless communications network to the second data processing device. The second data processing device transmits these received data directly to the Cloud server, for instance, and/or further processes these data itself and transmits the further processed data to the Cloud server. These further processed data, too, may generally be described as environment data to the extent that they are based on the environment sensor data of the environment sensors. These further processed data may also be denoted as further environment data in the following text.

In one specific embodiment, it is provided that the Cloud server is configured to ascertain dimensions of a free space of the environment and/or dimensions of an area of the environment occupied by a motor vehicle based on the environment sensor data and/or the environment data, and to ascertain environment data that correspond to the ascertainment of the respective dimensions.

In one specific embodiment, it is provided that the first data processing device is configured to condition the environment sensor data and to transmit the conditioned environment sensor data to the second data processing device. The conditioned environment sensor data particularly constitute environment data in the sense of this description.

The conditioning, for example, includes a compression and/or fusing of the environment sensor data.

For instance, it is provided that the first data processing device merely conditions the environment sensor data, i.e. does not calculate dimensions of free and/or occupied parking spaces based on the environment sensor data, as previously described. This task is assumed by the second data processing device and/or the Cloud server, for instance.

In one specific embodiment, it is provided that the environment sensor data are received through a wired connection with the aid of the communications interface of the parking control unit. For example, the parking control unit uses these environment data to carry out calculations, as described in the previous and/or the following text, e.g., in order to ascertain dimensions of free parking spaces or parking areas.

The present invention will be described in greater detail in the following text based on exemplary embodiments.

### BRIEF DESCRIPTION OF THE DRAWINGS

FIG. 1 shows a device for sensing an environment of a motor vehicle.

FIG. 2 shows a flow diagram of a method for sensing an environment of a motor vehicle.

FIG. 3 shows a flow diagram of a method for adapting a motor vehicle.

FIG. 4 shows a motor vehicle.

### DETAILED DESCRIPTION

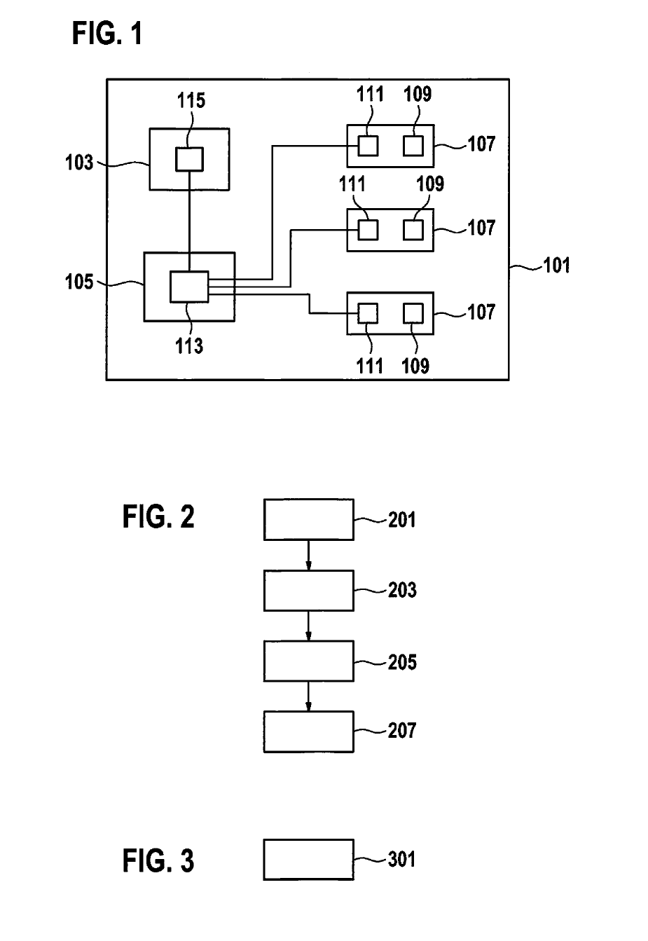

FIG. 1 shows a device 101 for sensing an environment of a motor vehicle. Device 101 includes:
a parking control unit 103;
a first data processing device 105;
a plurality of sensor units 107, each including an environment sensor 109 for sensing an environment of a motor vehicle, and a communications interface 111 for the wired transmission of environment sensor data corresponding to the respective sensing;
the parking control unit having a communications interface 115, which is configured to receive the environment sensor data in a wired manner;
first data processing device 105 having a communications module 113, which is configured to receive the environment sensor data from at least one communications interface 111 of sensor unit(s) 107 in a wired manner;
communications module 113 being configured to transmit the environment sensor data and/or environment data based on the environment sensor data by way of a wireless communications network to a second data processing device, so that the second data processing device is able to transmit the environment sensor data and/or the environment data by way of a further wireless communications network to a Cloud server.

In device 101 shown in FIG. 1, the environment sensor data are looped through first data processing device 105 to parking control unit 103.

In another specific embodiment, it is provided that first data processing device 105 and parking control unit 103 are connected to sensor units 107 in parallel in each case in terms of communications technology.

According to one specific embodiment, device 101 includes the second data processing device, which is configured to transmit the environment sensor data and/or the environment data by way of the further wireless communications network to the Cloud server.

According to one specific embodiment, a motor vehicle is provided, which includes device 101.

In one specific embodiment, it is provided that the first data processing device and/or the second data processing device include(s) a position sensor for sensing a position of the motor vehicle. The position sensor is a GPS sensor, for example.

Parking control unit 103, for instance, includes a control unit, which is configured to control a transverse and/or longitudinal guidance of a motor vehicle.

FIG. 2 shows a flow diagram of a method for sensing an environment of a motor vehicle using the device for sensing an environment of a motor vehicle, e.g., device 101 of FIG. 1.

The present method includes the following steps:
Sensing 201 an environment of a motor vehicle with the aid of the environment sensor(s);
wired transmitting 203 of environment sensor data corresponding to the sensing with the aid of the respective communications interface of the sensor unit(s); and
wired receiving 205 of the environment sensor data with the aid of the first data processing device; and
transmitting 207 environment sensor data and/or environment data based on the environment sensor data to the second data processing device by way of a wireless communications network using the first data processing device, so that the second data processing device is able to transmit the environment sensor data and/or the environment data to a

Cloud server by way of a further wireless communications network.

According to one specific embodiment, it is provided that the second data processing device transmits the environment sensor data and/or the environment data to the Cloud server by way of the further wireless communications network.

In one specific embodiment, it is provided that the environment sensor data are looped through the first data processing device to the parking control unit.

In one specific embodiment, it is provided that the parking control unit receives the environment sensor data in a wired manner.

FIG. 3 shows a flow diagram of a method for adapting a motor vehicle, the motor vehicle having a parking control unit and one or a plurality of sensor unit(s), each having one or a plurality of environment sensors for sensing an environment of a motor vehicle, and a communications interface for the wired transmission of environment sensor data corresponding to the respective sensing via a bus, in particular a CAN bus, of the motor vehicle, and the parking control unit having a bus communications interface for the wired receiving of the environment sensor data via the bus, a first data processing device having a communications module being installed 301 in the motor vehicle, the communications module being configured to receive the environment sensor data in a wired manner, e.g., via the bus, the communications module being configured to transmit the environment sensor data and/or environment data based on the environment sensor data via a wireless communications network to a second data processing device.

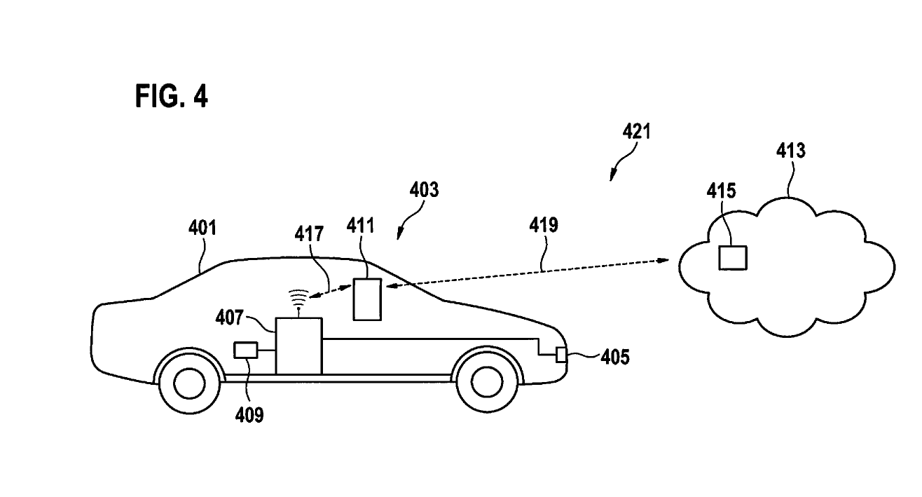

FIG. 4 shows a motor vehicle 401.

Motor vehicle 401 includes a device 403 for sensing an environment of a motor vehicle.

Device 403 includes a sensor unit 405, which encompasses an environment sensor for sensing an environment of motor vehicle 401, and a communications interface for the wired transmission of environment sensor data corresponding to the sensing to a first data processing device 407 and to a parking control unit 409.

The communications interface and the environment sensor of sensor unit 405 are not shown for the sake of clarity.

Device 403 includes first data processing device 407 and parking control unit 409, which, for example, is configured to park and/or unpark a motor vehicle, in this instance in particular motor vehicle 401, in an at least semi-autonomous, and in particular, in a fully autonomous manner.

First data processing device 407 includes a communications module. The communications module is configured to receive the environment sensor data in a wired manner. In addition, the communications module is configured to transmit the environment sensor data and/or environment data based on the environment sensor data by way of a wireless communications network to a second data processing device 411, so that second data processing device 411 is able to transmit, or transmits, the environment sensor data and/or the environment data and/or further environment data that are based on the environment sensor data and/or based on the environment data via a further wireless communications network to a Cloud server 413.

The communications module of first data processing device 407 is not shown for the sake of clarity.

The environment sensor of sensor unit 405 senses an environment of motor vehicle 401 and transmits environment sensor data that correspond to this sensing with the aid of the communications interface to first data processing device 407 and to parking control unit 409. This transmission is carried out in a wired manner, e.g., via a bus of motor vehicle 401.

Parking control unit 409 ascertains dimensions of a free area of the environment and/or dimensions of an area of the environment occupied by a motor vehicle based on the environment sensor data, for instance, and ascertains environment data that correspond to the ascertainment of the respective dimensions.

Parking control unit 409 is indirectly connected to sensor unit 405 with the aid of first data processing device 407. In other words, the environment sensor data are looped through first data processing device 407 to parking control unit 409.

First data processing device 407 ascertains dimensions of a free area of the environment based on the environment sensor data, for example, and/or dimensions of an area of the environment occupied by a motor vehicle, and ascertains environment data that correspond to the ascertainment of the respective dimensions.

First data processing device 407 transmits these data via a wireless communications network to second data processing device 411. Second data processing device 411 is encompassed by device 403, for example. Second data processing device 411 is included by vehicle 401, for instance. Second data processing device 411 is disposed inside the motor vehicle, in particular.

Second data processing device 411, for example, is a mobile user terminal, such as a mobile telephone, of a driver or of a vehicle passenger of motor vehicle 401.

Second data processing device 411 is a main control unit of motor vehicle 401, for instance.

For example, second data processing device 411 includes a first communications interface such as a WLAN or a Bluetooth communications interface for the receiving of the environment sensor data or the environment data from first data processing device 407 via the wireless communications network.

Second data processing device 411, for instance, includes a second communications interface, e.g., a mobile telephony communications interface, for the transmission of the environment sensor data and/or the environment data and/or the further environment data to Cloud server 413.

The communications module of first data processing device 407, for instance, includes a first communications interface, e.g., a bus communications interface, for the wired receiving of the environment sensor data.

The communications module of first data processing device 407, for example, includes a second communications interface, e.g., a WLAN communications interface or a Bluetooth communications interface, for the wireless transmission of the environment sensor data and/or the environment data to second data processing device 411.

Cloud server 413 includes a communications interface 415, which is configured to receive the environment sensor data and/or the environment data and/or the further environment data via the further wireless communications network from second data processing device 411.

The communication between first data processing device 407 and second data processing device 411 is denoted by a double arrow bearing reference numeral 417.

The communication between second data processing device 411 and Cloud server 413 is denoted by a double arrow bearing reference numeral 419.

Cloud server 413, for example, is configured to ascertain free or occupied parking spaces in the environment of motor vehicle 401 as well as their positions, e.g., GPS positions, based on the received data.

This information, i.e. especially the positions of the free or occupied parking areas or parking spaces, is transmitted to motor vehicle 401, for example, via the further wireless communications network. This information is transmitted to further motor vehicles (not shown), for instance, via the further wireless communications network so that they obtain knowledge of where occupied or free, i.e. unoccupied, parking spaces or parking areas are located.

FIG. 4 thus also shows a system 421 for sensing an environment of a motor vehicle.

System 421 includes device 403 as well as Cloud server 413.

Providing a Cloud server 413 in particular has the technical advantage that it is efficiently able to carry out calculations; in particular, it is able to efficiently receive a multitude of environment sensor data and/or environment data and/or further environment data from a multitude of motor vehicles and process and/or evaluate them efficiently and transmit corresponding results of this processing or this evaluation (e.g., the positions of the free or occupied parking spaces) to the multitude of motor vehicles via the further wireless communications network.

According to one specific embodiment, it is provided that second data processing device 411 is configured to indicate the information of Cloud server 413 that is transmitted via the further wireless communications network.

Second data processing device 411, for instance, includes a display screen for displaying this information.

Thus, the present invention particularly encompasses the idea of installing an additional hardware component, i.e. the first data processing device, in a motor vehicle, which is able to receive the environment sensor data from the environment sensor in a wired manner and is able to transmit these environment sensor data or environment data that are based on these environment sensor data in a wireless manner to a second data processing device by way of a wireless communications network. For instance, this achieves the technical advantage that no essential changes or modifications have to be made to a bus of a motor vehicle, for example.

This therefore means that the additional hardware component that is installed in the motor vehicle after the adaptation has two functionalities: a cable-free or wireless communication in addition to a wired communication.

The terms ‘cable-free’ and/or ‘wireless’ in the sense of the description may be used as synonyms.

In other words, the newly installed hardware component has a communications module which is configured to communicate wirelessly via a wireless communications network, i.e. in particular transmit the environment sensor data and/or environment data to a second data processing device in a wireless manner.

The environment sensor data, which may include raw environment sensor data, and/or the environment data, for instance, are able to be transmitted to the second data processing device, which is a mobile user terminal, for example.

The data are transmitted in encrypted form, for instance.

For example, a position sensor for sensing a position of the motor vehicle is provided so that it is possible to allocate a position to the environment sensor data and/or so that it is possible to allocate a position to the environment data. Thus, this means that a position of the motor vehicle, i.e. corresponding position data, is linked to the environment data and the environment sensor data, respectively.

For example, the first data processing device and the second data processing device include a position sensor in each case so that the data processing device and/or the further data processing device is/are able to sense or determine a position of the motor vehicle at the instant when the environment of the motor vehicle is sensed.

According to one specific embodiment, it is provided that the first data processing device and/or the second data processing device and/or the parking control unit is/are configured to determine dimensions of a free area of the environment and/or dimensions of an area of the environment occupied by a motor vehicle based on the environment sensor data and the environment data respectively, and to ascertain environment data corresponding to the ascertainment of the respective dimensions, i.e. the further environment data in this case. The dimensions together with the corresponding positions of the free areas and/or the occupied areas are then transmitted to the Cloud server via the further wireless communications network, for instance with the aid of the second data processing device.

According to one specific embodiment, it is provided that in addition to or instead of the afore-described ascertaining of the dimensions of the free areas and/or the occupied areas with the aid of the first data processing device and/or with the aid of the parking control unit and/or with the aid of the second data processing device, the corresponding calculations are performed using the Cloud server.

According to one specific embodiment, the Cloud server is configured to calculate further data, e.g., whether the free area is a driveway, based on the received data (e.g., environment sensor data, environment data, further environment data). For example, the Cloud server ascertains whether or not a parking space is fully occupied or whether further free parking spaces are still available inside a parking space.

The data ascertained or calculated by the Cloud server may be transmitted via the further wireless communications network to the second data processing device and/or to further motor vehicles so that the second data processing device or data processing devices of the further motor vehicles are able to display this information.

According to one specific embodiment, it is provided that the second data processing device is a head unit, i.e. a main control unit. According to this specific embodiment, the main control unit includes a cable-free communications interface. In other words, the cable-free communications interface is able to communicate in a wireless manner. For instance, it is provided that the communications interface of the main control unit may communicate in a wireless manner via Bluetooth and/or WLAN.

In other words, according to this specific embodiment, the data are transmitted wirelessly from the additional hardware component to the main control unit and are then transmitted from the main control unit to the Cloud server in a wireless manner via the further wireless communications network.

As a rule, a motor vehicle is already equipped with a main control unit, which includes an infotainment system, for example. A main control unit already installed in the motor vehicle usually already has a communications interface for a wireless communication. In the case of already known motor vehicles, it is provided, for instance, that the main control unit communicates with a mobile phone of a vehicle passenger via such a communications interface in order to play music that is stored on the mobile telephone with the aid of the infotainment system, for example.

It is therefore no longer necessary to make further modifications to the main control unit with regard to hardware. Instead, it is sufficient to provide a software update for such a main control unit. This normally involves no great effort and generally entails no additional hardware costs.

The concept according to the present invention offers the particular advantage that already existing motor vehicles, that is to say, already completed motor vehicles, may retroactively still become part of a system for ascertaining free or movable parking areas along the roadside. According to the present invention, this is achieved with the aid of the device, and with the aid of an installation of an additional hardware component, respectively, i.e. especially in addition to the parking control unit.

More specifically, no significant modifications of the bus of the motor vehicle will have to be implemented.

In particular, provided the first data processing device already includes a position sensor, no additional position sensing components have to be installed in the motor vehicle.

More specifically, no modifications of the main control unit other than the software update are required if the communication with the Cloud server is not to be carried out via a mobile phone but via the main control unit.

In particular, no modifications of the parking control unit are necessary.

In particular, no modifications of the sensor units have to be carried out.

1-20. (canceled)

21. A device for sensing an environment of a motor vehicle, comprising:
a parking control unit;
a first data processing device;
one or a plurality of sensor unit(s), each having one or a plurality of environment sensor(s) for sensing an environment of a motor vehicle, and a communications interface for the wired transmission of environment sensor data corresponding to the respective sensing;
wherein the parking control unit has a communications interface to receive the environment sensor data in a wired manner,
wherein the first data processing device has a communications module to receive the environment sensor data from at least one communications interface of the sensor unit(s) in a wired manner, and
wherein the communications module is configured to transmit the environment sensor data and/or environment data based on the environment sensor data via a wireless communications network to a second data processing device, so that the second data processing device is able to transmit the environment sensor data and/or the environment data via a further wireless communications network to a Cloud server.

22. The device of claim 21, wherein the second data processing device is configured to transmit the environment sensor data and/or the environment data via the further wireless communications network to the Cloud server.

23. The device of claim 21, wherein the second data processing device includes a mobile user terminal and/or a mobile phone.

24. The device of claim 21, wherein the second data processing device includes a main control unit for a motor vehicle.

25. The device of claim 21, wherein the parking control unit and the first data processing device are switched in parallel with at least one of the respective communications interfaces of the sensor unit(s) in terms of communications technology, so that the parking control unit and the first data processing device are directly connected to the at least one communications interface in each case.

26. The device of claim 21, wherein the parking control unit is indirectly connected to at least one of the respective communications interfaces with the aid of the first data processing device in terms of communications technology, so that the environment sensor data transmitted via the at least one communications interface are loop-able through the first data processing device to the parking control unit.

27. The device of claim 21, wherein the communications module has a first communications interface, in particular a bus communications interface, for the wired receiving of the environment sensor data, and a second communications interface, in particular a WLAN or a Bluetooth communications interface, for the transmission of the environment sensor data and/or the environment data to the second data processing device.

28. The device of claim 21, wherein the parking control unit and/or the first data processing device and/or the second data processing device is/are configured to ascertain dimensions of a free area of the environment and/or dimensions of an area of the environment occupied by a motor vehicle based on the environment sensor data, and to ascertain environment data corresponding to the ascertainment of the respective dimensions.

29. The device of claim 21, wherein a position sensor for sensing a position of the motor vehicle is provided, and the first data processing device is configured to transmit position data corresponding to the sensing of the position to the further data processing device, so that the second data processing device is able to transmit the position data via the further wireless communications network to the Cloud server.

30. The device of claim 29, wherein the position sensor is integrated into the first data processing device or into the second data processing device.

31. The device of claim 21, wherein the sensor unit(s) is configured to encrypt the environment sensor data, and the respective communications interface of the sensor unit(s) is configured to transmit the encrypted environment sensor data in a wired manner.

32. The device of claim 21, wherein the first data processing device includes an electrical connection for connecting an electrical line in order to be able to supply the first data processing device with electrical energy from a motor vehicle battery.

33. The device of claim 21, wherein the first data processing device includes an electrical energy store for the internal electrical energy supply.

34. A motor vehicle, comprising:
a device for sensing an environment of a motor vehicle, including:
a parking control unit;
a first data processing device;
one or a plurality of sensor unit(s), each having one or a plurality of environment sensor(s) for sensing an environment of a motor vehicle, and a communications interface for the wired transmission of environment sensor data corresponding to the respective sensing;
wherein the parking control unit has a communications interface to receive the environment sensor data in a wired manner,
wherein the first data processing device has a communications module to receive the environment sensor data from at least one communications interface of the sensor unit(s) in a wired manner, and
wherein the communications module is configured to transmit the environment sensor data and/or environment data based on the environment sensor data via a wireless communications network to a second data processing device, so that the second data processing device is able to transmit the environment sensor data and/or the environment data via a further wireless communications network to a Cloud server.

35. The motor vehicle of claim 34, wherein the communications module is connected by a wired connection only to the particular communications interface of the sensor unit(s) whose environment sensors are mounted laterally to the right and/or left of the motor vehicle.

36. A method for sensing an environment of a motor vehicle using a device, the method comprising:
sensing an environment of a motor vehicle using environment sensor(s), wherein the device includes:
a parking control unit;
a first data processing device;
one or a plurality of sensor unit(s), each having one or a plurality of the environment sensor(s) for sensing an environment of a motor vehicle, and a communications interface for the wired transmission of environment sensor data corresponding to the respective sensing;
wherein the parking control unit has a communications interface to receive the environment sensor data in a wired manner,
wherein the first data processing device has a communications module to receive the environment sensor data from at least one communications interface of the sensor unit(s) in a wired manner, and
wherein the communications module is configured to transmit the environment sensor data and/or environment data based on the environment sensor data via a wireless communications network to a second data processing device, so that the second data processing device is able to transmit the environment sensor data and/or the environment data via a further wireless communications network to a Cloud server;
providing wired transmitting of environment sensor data corresponding to the sensing with the aid of the respective communications interface of the sensor unit(s);
providing wired receiving of the environment sensor data with the aid of the first data processing device; and
transmitting the environment sensor data and/or environment data based on the environment sensor data via a wireless communications network with the aid of the first data processing device to a second data processing device, so that the second data processing device is able to transmit the environment sensor data and/or the environment data via a further wireless communications network to the Cloud server.

37. A system of adapting a motor vehicle, comprising:
a parking control unit; and
one or more sensor unit(s), each having one or a plurality of environment sensor(s) for sensing an environment of a motor vehicle, and a communications interface for the wired transmission of environment sensor data corresponding to the respective sensing via a bus or a CAN bus, of the motor vehicle;
wherein the parking control unit includes a bus communications interface for the wired receiving of the environment sensor data via the bus, and
wherein a first data processing device including a communications module is installed in the motor vehicle, the communications module being configured to receive the environment sensor data in a wired manner, via the bus, the communications module being configured to transmit the environment sensor data and/or environment data based on the environment sensor data via a wireless communications network to a second data processing device.

38. A system for sensing an environment of a motor vehicle, comprising:
a device for sensing an environment of a motor vehicle, including:
a parking control unit;
a first data processing device;
one or a plurality of sensor unit(s), each having one or a plurality of environment sensor(s) for sensing an environment of a motor vehicle, and a communications interface for the wired transmission of environment sensor data corresponding to the respective sensing;
wherein the parking control unit has a communications interface to receive the environment sensor data in a wired manner,
wherein the first data processing device has a communications module to receive the environment sensor data from at least one communications interface of the sensor unit(s) in a wired manner, and
wherein the communications module is configured to transmit the environment sensor data and/or environment data based on the environment sensor data via a wireless communications network to a second data processing device, so that the second data processing device is able to transmit the environment sensor data and/or the environment data via a further wireless communications network to a Cloud server; and
the Cloud server, which includes a communications interface to receive the environment sensor data and/or the environment data via the further wireless communications network.

39. The system of claim 38, wherein the Cloud server is configured to ascertain dimensions of a free area of the environment and/or dimensions of an area of the environment occupied by a motor vehicle based on the environment sensor data and/or the environment data, and to ascertain environment data that correspond to the ascertainment of the respective dimensions.

40. A computer readable medium having a computer program, which is executable by a processor, comprising:
a program code arrangement having program code for sensing an environment of a motor vehicle using a device, by performing the following:
sensing an environment of a motor vehicle using environment sensor(s), wherein the device includes:
a parking control unit;
a first data processing device;
one or a plurality of sensor unit(s), each having one or a plurality of the environment sensor(s) for sensing an environment of a motor vehicle, and a communications interface for the wired transmission of environment sensor data corresponding to the respective sensing;
wherein the parking control unit has a communications interface to receive the environment sensor data in a wired manner,
wherein the first data processing device has a communications module to receive the environment sensor data from at least one communications interface of the sensor unit(s) in a wired manner, and
wherein the communications module is configured to transmit the environment sensor data and/or environment data based on the environment sensor data via a wireless communications network to a second data processing device, so that the second data processing device is able to transmit the environment sensor data and/or the environment data via a further wireless communications network to a Cloud server;
providing wired transmitting of environment sensor data corresponding to the sensing with the aid of the respective communications interface of the sensor unit(s);
providing wired receiving of the environment sensor data with the aid of the first data processing device; and
transmitting the environment sensor data and/or environment data based on the environment sensor data via a wireless communications network with the aid of the first data processing device to a second data processing device, so that the second data processing device is able to transmit the environment sensor data and/or the environment data via a further wireless communications network to the Cloud server.
